(19) United States
(12) Patent Application Publication
(10) Pub. No.: US 2007/0018554 A1
(43) Pub. Date: Jan. 25, 2007

(54) Lamp with protective layer and process for producing a lamp of this type

(75) Inventors: Barbel Dierks, Wandlitz (DE); Hasnaa Sarroukh, Berlin (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, MUNCHEN (DE)

(21) Appl. No.: 11/485,460

(22) Filed: Jul. 13, 2006

(30) Foreign Application Priority Data
Jul. 19, 2005 (DE) 10 2005 034 145.4

(51) Int. Cl. H01J 5/48

(52) U.S. Cl. 313/318.08

(57) ABSTRACT

A lamp 8 has a lamp vessel 16, a portion 58 of which is received in a receiving part 44 of a holding body 4 and fixed by a joining compound 48, wherein a protective layer 60 is applied to the portion 58. A process for producing a lamp of this type is also disclosed.

### TECHNICAL FIELD

The invention relates to a lamp in accordance with the preamble of patent claim 1 and to a process for producing a lamp of this type in accordance with patent claim 6.

### BACKGROUND ART

A lamp of this type is disclosed, for example, in U.S. Pat. No. 6,784,601 B2. This lamp is a reflector high-pressure discharge lamp having a reflector which delimits an interior, and having a discharge vessel made from quartz glass. The discharge vessel projects into the interior, with a stem, passing through a neck region of the reflector, in which it is fixed by means of a joining compound. Problems with this form of fixing are that the stem surrounded by the joining compound is attacked by the chemical composition of the joining compound, setting conditions and temperature-dependent stresses during lamp operation, and forces are exerted on the stem which can lead to the stem breaking and therefore to the lamp failing. Furthermore, the joining compound can give rise to sharp notches in the quartz glass, which, as it were, act as preferential breaking points. To avoid damage of this nature, it is customary to aim for a compromise between the holding forces required of the joining compound and the probability of the stem breaking. However, it has been found that even with the minimum required holding forces between the joining compound and the stem, there is a significant risk of the stem breaking.

### DISCLOSURE OF THE INVENTION

The invention is based on the object of providing a lamp and a process for producing such a lamp which has an improved stability compared to conventional solutions.

The lamp according to the invention has a lamp vessel, a portion of which is received in a receiving part of a holding body and fixed by means of a joining compound. According to the invention, a protective layer is applied to the portion. According to the invention, the process according to the invention for producing a lamp includes the steps of:

applying a protective layer to a portion of a lamp vessel, setting the protective layer,

positioning the portion in a receiving part of a holding body, and

fixing the portion in the receiving part using a joining compound.

The solution according to the invention has the advantage that on account of the protective layer the joining compound no longer directly attacks the lamp vessel, with the result that there is no damage to the lamp vessel caused by the joining compound, and therefore the probability of the lamp vessel breaking is not increased.

According to a particularly preferred exemplary embodiment, the protective layer is a set suspension of the joining compound.

It is preferable for an additive to be added to the suspension in order to improve the viscosity and to reduce the aggressive properties of the joining compound.

In an exemplary embodiment, the joining compound contains Sauereisen cement as well as glass beads or Aerosil® as additive.

The protective layer preferably has a layer thickness of approximately at most 1 mm. In particular, a layer thickness of 0.1 mm is conceivable.

The setting of the suspension can take place at a temperature of approximately 250° C.

### BRIEF DESCRIPTION OF THE DRAWINGS

In the text which follows, the invention is explained in more detail on the basis of a preferred exemplary embodiment, in which:

FIG. 1 diagrammatically depicts a lamp according to the invention, and

FIG. 2 shows an enlarged view of a neck region of the lamp from FIG. 1.

### BEST MODE FOR CARRYING OUT THE INVENTION

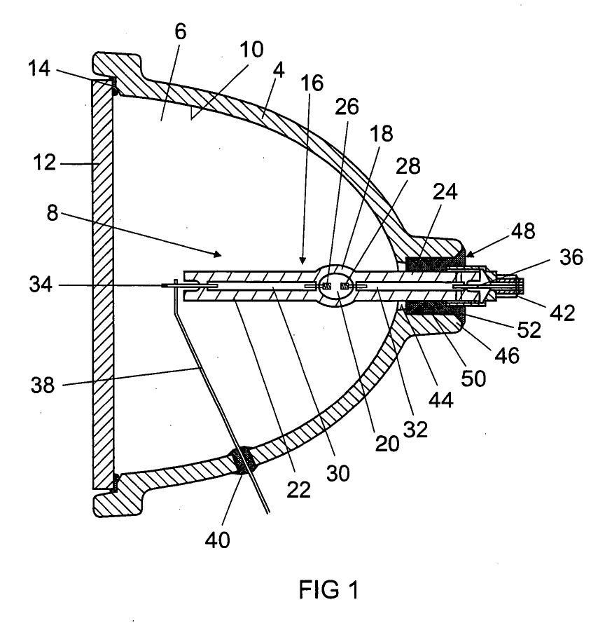

FIG. 1 shows, by way of example, a diagrammatic illustration of a reflector lamp 2 according to the invention having a reflector 4, into the interior 6 of which a high-pressure discharge lamp 8 projects, passing through a neck region of the reflector 4. The reflector 4 is substantially ellipsoidal and consists of pressed glass with a reflecting coating applied to its inner surface 10. On its side on which the light emerges, the interior 6 is delimited by a pane 12 which serves to protect against splintering and is fitted into a radial widening of the reflector 4. The pane 12 consists of glass and is joined to the reflector 4 by means of an adhesive 14, for example comprising silicone.

The high-pressure discharge lamp 8 has a discharge vessel 16 made from quartz glass, which has a discharge bulb 18 for delimiting a discharge space 20 and also has two stems 22, 24 arranged diametrically on the discharge bulb 18. Two electrodes 26, 28, which are arranged diametrically with respect to one another and between which a gas discharge is formed while the lamp is operating, project into the discharge space 20. The discharge space 20 is filled with an ionizable fill which substantially comprises a high-purity noble gas. The electrodes 26, 28 are made from tungsten and are fused into the stems 22, 24 by means of sealing foils 30, 32 in a known way. It is preferable for the sealing foils 30, 32 to consist of molybdenum. Supply conductors 34, 36 are welded onto an end portion of the sealing foils 30, 32 that is remote from the discharge space 20. A power line 38, which is routed through a lateral leadthrough 40 in the reflector 4, engages on the left-hand supply conductor 34, as seen in FIG. 1, in order for a supply voltage to be applied to the high-pressure discharge lamp 8. The right-hand supply conductor 36, as seen in FIG. 1, is directly connected to a cap 42 which engages around a free end of the stem 24 arranged outside the interior 6.

The neck region of the reflector 4 is formed as a cylindrical projection 46, in which is formed a bore 44, which widens radially in the direction away from the interior 6, for the stem 24 to pass through. The high-pressure discharge lamp 8 is fixed by means of a joining compound 48, which is placed in an annular space 50 between the stem 24 and an inner wall 52 of the bore 44 and likewise encloses the cap 42 in portions, so that the cap is securely joined to the stem 24. The joining compound 48 is a ceramic cement based on silicate, which is known per se, or a Sauereisen cement, and when it is introduced into the annular space 50 is preferably so viscous that it does not flow into the interior 6. However, it is also possible for the annular space 50 to be delimited in the direction of the interior 6 by a ring (not shown) inserted into the radial widening of the bore 44, so that in the event of a lower viscosity the joining compound 48 is prevented from penetrating out of the annular space 50 into the interior 6 of the reflector 4.

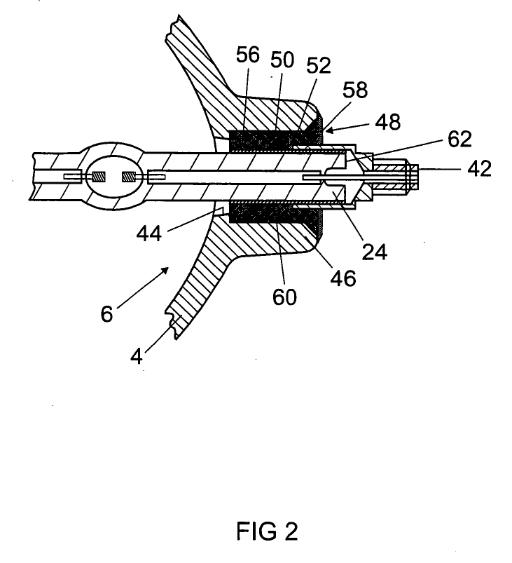

As can be seen from the enlarged illustration of the neck region in FIG. 2, according to the invention a protective layer 60 has been applied to a portion 58 of the stem 24 which passes through the bore 44, which protective layer substantially extends from a shoulder surface 56 of the bore 44 to the end face 62 of the stem 24, which is covered by the cap 42. The protective layer 60 means that the joining compound 48 does not directly attack the stem 24, and therefore the joining compound 48 cannot introduce sharp notches into the quartz glass of the portion 58, thereby increasing the stability of the reflector lamp 2 according to the invention compared to known solutions. The protective layer 60 prevents the stem 24 from being damaged, which increases the probability of it breaking. It is preferable for the protective layer 60 to be applied in a layer thickness of less than 1 mm, the layer thickness preferably being 0.1 mm.

However, it is also conceivable for a plurality of protective layers 60 to be provided on top of one another, i.e. in multilayer form, on the portion 58. Of course, the layer thickness of the individual protective layers 58 and their composition may in this case vary.

In the exemplary embodiment illustrated, the protective layer 60 is a suspension of the joining compound 48, the joining compound 48 having been diluted with water in order to produce the suspension. To increase the viscosity and to reduce the aggressive properties of the joining compound, at least one additive may be admixed with the suspension. Examples of possible additives include hollow glass beads in a powder, which are known for the preparation of lightweight knifing fillers, adhesives and molding compounds, or Aerosil®, which is known per se. The composition of the suspension is selected in such a way that the protective layer 60 substantially does not attack the quartz glass, while at the same time sufficient bonding to the portion 58 is achieved. In this context, it has emerged that the protective layer 50 is pressed onto the stem 24 by the set joining compound 48, thereby improving the bonding of the protective layer 60 to the portion 58. An example of a composition of the suspension contains 30% of the joining compound 48, 50% water and 20% of one or more of the additives.

To produce the reflector lamp 2 according to the example of the invention, first of all the protective layer 60 is applied to the portion 58. Then, the protective layer 60 is dried, preferably in air, and set in a furnace at approximately 250° C. Then, the coated portion 58 of the high-pressure discharge lamp 8 is guided through the bore 44 and the ceramic ring 54 is inserted. Next, the annular space 50 is at least partially filled with the joining compound 48, so that the high-pressure discharge lamp 8, at least in the vicinity of a ceramic ring (not shown here), is surrounded by the joining compound 48, and is therefore fixedly joined to the reflector 4 after setting of the joining compound 48.

It should be mentioned that the protective layer 60 according to the invention is not restricted to the suspension of the joining compound 48 described here by way of example; rather, other compositions and materials are also possible for producing the protective layer 60.

The invention discloses a lamp having a lamp vessel 16, a portion 58 of which is received in a receiving part 44 of a holding body 4 and fixed by means of a joining compound 48, wherein a protective layer 60 is applied to the portion 58. The invention also discloses a process for producing a lamp of this type.

List of Designations:

2 Reflector lamp
4 Reflector
6 Interior
8 High-pressure discharge lamp
10 Inner surface
12 Pane
14 Adhesive
16 Discharge vessel
18 Discharge bulb
20 Discharge space
22 Stem
24 Stem
26 Electrode
28 Electrode
30 Sealing foil
32 Sealing foil
34 Supply conductor
36 Supply conductor
38 Power line
40 Leadthrough
42 Cap
44 Bore
46 Projection
48 Joining compound
50 Annular space
52 Inner wall
56 Shoulder surface
58 Portion
60 Protective layer
62 End face

1. A lamp having a lamp vessel, a portion of which is received in a receiving part of a holding body and fixed by means of a joining compound, wherein at least one protective layer is applied to the portion.

2. The lamp as claimed in claim 1, wherein the protective layer is a set suspension of the joining compound.

3. The lamp as claimed in claim 2, wherein the suspension contains an additive for improving the viscosity.

4. The lamp as claimed in claim 3, wherein the joining compound contains Sauereisen cement and the additive includes glass beads or Aerosil®.

5. The lamp as claimed in claim 1, wherein the protective layer has a layer thickness of approximately at most 1 mm, preferably 0.1 mm.

6. A process for producing the lamp as claimed in claim 1, comprising the steps of:
applying a protective layer to a portion of a lamp vessel,
setting the protective layer,
positioning the portion in a receiving part of a holding body, and
fixing the portion in the receiving part using a joining compound.

7. The process as claimed in claim 6, wherein the protective layer is applied in the form of a suspension of the joining compound.

8. The process as claimed in claim 7, wherein the suspension is set at a temperature of approximately 250° C.
